(19) United States
(12) Patent Application Publication
(10) Pub. No.: US 2019/0301396 A1
(43) Pub. Date: Oct. 3, 2019

(54) CYLINDER HEAD COVER AND WELDING APPARATUS

(71) Applicants: TOYOTA JIDOSHA KABUSHIKI KAISHA, Toyota-shi (JP); MAHLE FILTER SYSTEMS JAPAN CORPORATION, Toshima-ku (JP)

(72) Inventors: Kae OHKI, Toyota-shi (JP); Daizo ITO, Saitama-shi (JP); Masanori SUDO, Kawagoe-shi (JP)

(73) Assignees: TOYOTA JIDOSHA KABUSHIKI KAISHA, Toyota-shi (JP); MAHLE FILTER SYSTEMS JAPAN CORPORATION, Toshima-ku (JP)

(21) Appl. No.: 16/360,239

(22) Filed: Mar. 21, 2019

(30) Foreign Application Priority Data
Mar. 28, 2018 (JP) 2018-062739

(51) Int. Cl. F02F 7/00; F01M 9/10; B23K 20/10

(52) U.S. Cl. CPC F02F 7/006; F01M 13/0416; B23K 20/10; F01M 9/10

(57) ABSTRACT

A cylinder head cover is mounted on a cylinder head of an internal combustion engine to cover a camshaft supported by the cylinder head. The cylinder head cover includes a cover main body and a baffle plate. The cover main body includes a head mounting surface to be connected to the cylinder head and a bulging portion bulging away from the cylinder head farther than the head mounting surface. The bulging portion includes a recess that is recessed to approach the head mounting surface. The recess includes a bottom wall inclined with respect to a horizontal plane in a state in which the cover main body is mounted on the internal combustion engine. The baffle plate is joined to a surface of the bulging portion facing the camshaft at least at a section corresponding to the bottom wall of the recess.

### BACKGROUND

The present disclosure relates to a cylinder head cover mounted on a cylinder head and a welding apparatus that manufactures the cylinder head cover.

A cylinder head cover disclosed in Japanese Laid-Open Patent Publication No. 2014-218974 includes a portion that bulges like a PCV chamber (referred to as a breather chamber in the above publication), which constitutes an oil separator of a blow-by gas recirculation device. Thus, the front side of the cylinder head cover has projections and recesses. The cylinder head cover also includes mounting holes to which ignition plugs are mounted.

Liquid such as rain water or oil can collect in the recesses on the front side of the cylinder head cover. Such liquid may possibly enter the space covered by the cylinder head cover through the mounting holes.

### SUMMARY

In accordance with one aspect of the present disclosure, a cylinder head cover is provided that is mounted on a cylinder head of an internal combustion engine to cover a camshaft supported by the cylinder head. The cylinder head cover includes a cover main body and a baffle plate. The cover main body includes a head mounting surface to be connected to the cylinder head and a bulging portion bulging away from the cylinder head farther than the head mounting surface. The bulging portion includes a recess that is recessed to approach the head mounting surface. The recess includes a bottom wall inclined with respect to a horizontal plane in a state in which the cover main body is mounted on the internal combustion engine. The baffle plate is joined to a surface of the bulging portion facing the camshaft at least at a section corresponding to the bottom wall of the recess.

To manufacture the above-described cylinder head cover, a welding apparatus configured to perform vibration welding of the baffle plate to the cover main body includes a jig configured to secure the cover main body and the baffle plate with each other and a vibration generating device configured to apply vibration to the jig. The jig is configured to hold the cover main body and the baffle plate in such a manner that a vibration direction of vibration applied by the vibration generating device and the bottom wall of the recess are parallel to each other and that the baffle plate abuts against the bottom wall.

Other aspects and advantages of the present disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the presently preferred embodiments together with the accompanying drawings in which:

FIG. 1 is a schematic diagram illustrating an internal combustion engine to which a cylinder head cover according to an embodiment is applied;

FIG. 2 is a top view of the cylinder head cover of FIG. 1;

FIG. 3 is a perspective view of the back side of the cylinder head cover of FIG. 2;

FIG. 4 is a cross-sectional view taken along line 4-4 of FIG. 2;

FIG. 5 is a diagram illustrating a welding apparatus according to the embodiment; and

FIG. 6 is a cross-sectional view of the welding apparatus of FIG. 5.

### DETAILED DESCRIPTION

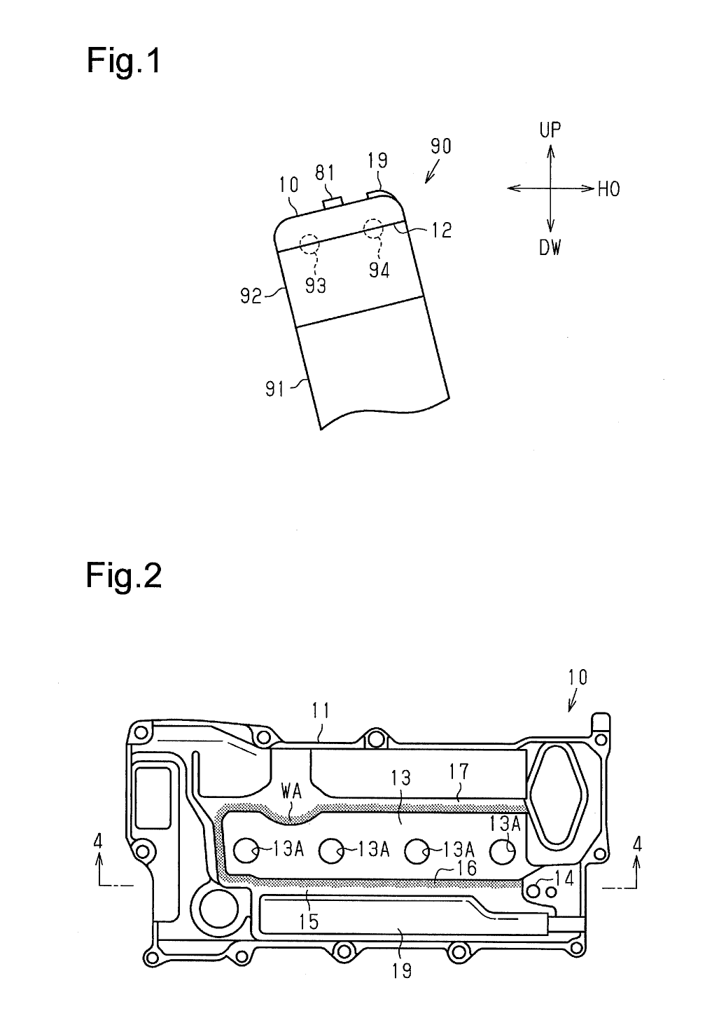

A cylinder head cover 10 according to an embodiment and a welding apparatus 40 for manufacturing the cylinder head cover 10 will be described with reference to FIGS. 1 to 6.

FIG. 1 shows an internal combustion engine 90 to which the cylinder head cover 10 is applied. FIG. 1 shows arrows indicating an upper side UP in the vertical direction, a lower side DW in the vertical direction, and a horizontal direction HO in a state in which the internal combustion engine 90 is installed in a vehicle.

FIG. 1 shows a cylinder block 91 of the internal combustion engine 90. The cylinder block 91 includes four cylinders. The internal combustion engine 90 includes a cylinder head 92 mounted on the cylinder block 91. The cylinder block 91 includes a surface to which the cylinder head 92 is mounted. The surface is oriented to face upward and is perpendicular to the central axes of the cylinders. The cylinder head 92 supports an intake camshaft 94 and an exhaust camshaft 93. The intake camshaft 94 is a camshaft that drives the intake valves. The exhaust camshaft 93 is a camshaft that drives the exhaust valves. The cylinder head cover 10 is mounted on the cylinder head 92 to cover the camshafts 93, 94. The cylinder head 92 includes a surface to which the cylinder head cover 10 is mounted. The surface is oriented to face upward and is perpendicular to the central axes of the cylinders.

The internal combustion engine 90 is installed in the vehicle in a state in which the internal combustion engine 90 is inclined with respect to the vertical direction as shown in FIG. 1. In this state, the exhaust camshaft 93 is located below the intake camshaft 94. That is, in a state in which the internal combustion engine 90 is installed in the vehicle, a head mounting surface 12 of the cylinder head cover 10 is inclined with respect to the horizontal direction HO. The head mounting surface 12 is located on a plane including the axis of the exhaust camshaft 93 and the axis of the intake camshaft 94. The axes of the camshafts 93, 94 extend horizontally.

The internal combustion engine 90 is provided with a blow-by gas recirculation device. The cylinder head cover 10 includes an oil separator of the blow-by gas recirculation device. The oil separator is a PCV chamber 19 in this embodiment. As shown in FIG. 1, the PCV chamber 19 is located in the vicinity of the upper edge of the inclined upper side (front side) of the internal combustion engine 90.

As shown in FIGS. 1 to 3, the cylinder head cover 10 includes a cover main body 11, which is connected to the cylinder head 92, and a baffle plate 21 located between the cover main body 11 and the cylinder head 92.

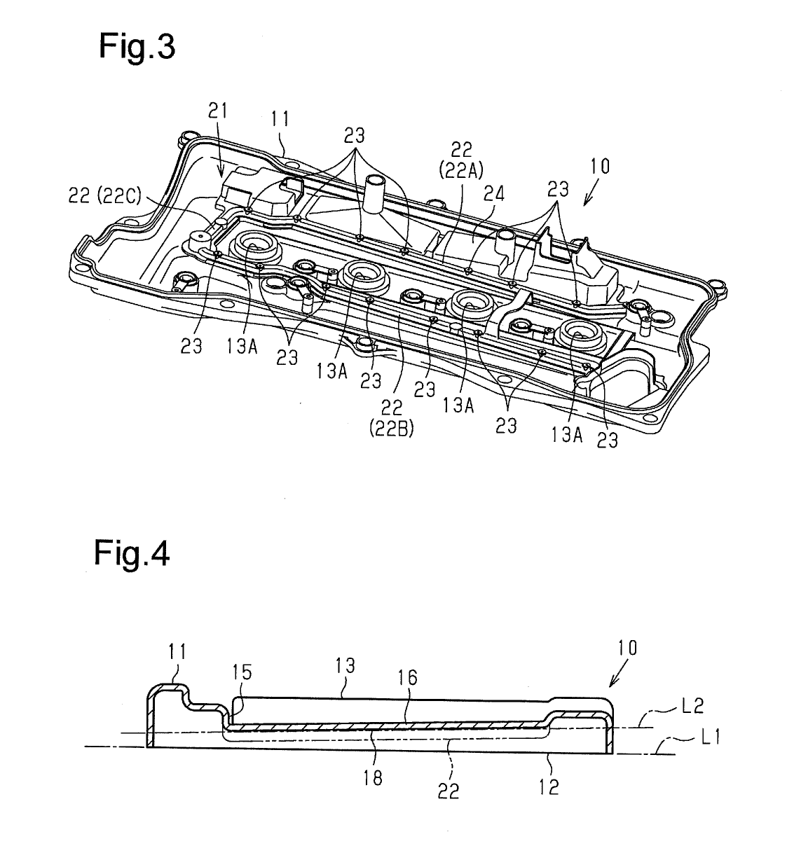

FIG. 3 shows the back side of the cylinder head cover 10, that is, the surface facing the cylinder head 92 and the camshafts 93, 94. The baffle plate 21 is mounted on the back side of the cover main body 11 by, for example, welding. The cover main body 11 includes the head mounting surface 12, which extends along the outer edge of the cover main body 11, and a bulging portion, which generally bulges away from the cylinder head 92 farther than the head mounting surface 12.

The cylinders of the internal combustion engine 90 are each provided with an electrode of the ignition plug. The ignition plugs are mounted to extend through the cylinder head 92. Each ignition plug includes an ignition coil 81 at the end opposite from the electrode. As shown in FIG. 1, the ignition coil 81 is mounted on the bulging portion of the cover main body 11 and projects from the front side of the cylinder head cover 10.

As shown in FIG. 2, the bulging portion of the cover main body 11 includes an ignition coil mounting portion 13. The ignition coil mounting portion 13 extends in the longitudinal direction of the cover main body 11 in the vicinity of the center of the cover main body 11 in the longitudinal direction and the transverse direction. The ignition coil mounting portion 13 includes four ignition coil mounting holes 13A in which the ignition coils 81 are inserted. The ignition coil mounting holes 13A extend from the front side of the cover main body 11 to the back side of the cover main body 11. The four ignition coil mounting holes 13A are arranged in the longitudinal direction of the cover main body 11. The right end of the cover main body 11 in the longitudinal direction in FIG. 2 is referred to as a first end, and the left end of the cover main body 11 in the longitudinal direction in FIG. 2 is referred to as a second end. In the transverse direction of the cover main body 11, the side on which the PCV chamber 19 is provided is referred to as an upper side with respect to the ignition coil mounting portion 13, and the opposite side is referred to as a lower side (see FIG. 1).

The cylinder head cover 10 includes a sensor mounting hole 14. The sensor mounting hole 14 is located in the vicinity of the first end of the ignition coil mounting portion 13 in the longitudinal direction of the cover main body 11. The sensor mounting hole 14 is located above the ignition coil mounting portion 13 in the transverse direction of the cover main body 11. A cam angle sensor that detects the rotational angle of the camshafts 93, 94 is mounted in the sensor mounting hole 14.

As shown in FIG. 3, the baffle plate 21 includes an oil shower pipe 22, which constitutes part of the oil passage of the internal combustion engine 90. The oil shower pipe 22 supplies lubricant to the valve actuation mechanism of the internal combustion engine 90. The oil shower pipe 22 extends along three sides (two long sides and one short side) of the outer edge of the substantially rectangular ignition coil mounting portion 13 on the back side of the cover main body 11.

The oil shower pipe 22 includes a first pipe 22A, a second pipe 22B, and a third pipe 22C. The first pipe 22A is located above the intake camshaft 94. The second pipe 22B is located above the exhaust camshaft 93. The third pipe 22C extends between a second end of the first pipe 22A in the longitudinal direction and a second end of the second pipe 22B in the longitudinal direction.

The oil shower pipe 22 includes oil discharge portions 23. The oil discharge portions 23 are open at positions where the lubricant can be supplied to the cams on the camshafts 93, 94 or the rocker arms, against which the cams abut. The oil discharge portions 23 extend in a direction orthogonal to the flowing direction of the lubricant through the oil shower pipe 22.

The baffle plate 21 includes a chamber lower section 24, which constitutes the bottom surface of the PCV chamber 19. The space in the PCV chamber 19 is defined by the cover main body 11 and the chamber lower section 24 of the baffle plate 21.

FIG. 4 shows a cross-sectional structure of the cylinder head cover 10.

As shown in FIGS. 2 and 4, the cover main body 11 of the cylinder head cover 10 includes a groove-shaped recess 15, which surrounds the ignition coil mounting portion 13. The recess 15 forms a groove that is recessed to approach the head mounting surface 12 more than the ignition coil mounting portion 13. The groove formed by the recess 15 extends along the oil shower pipe 22 of the baffle plate 21. The oil shower pipe 22 is welded to the region along the recess 15. That is, the groove is provided on the front side of the cover main body 11, and the oil shower pipe 22 is welded to the section on the back side of the cover main body 11 corresponding to the groove (recess 15). The recess 15 includes a first groove 16, a second groove 17, and a third groove. The first groove 16, the second groove 17, and the third groove extend along the first pipe 22A, the second pipe 22B, and the third pipe 22C, respectively. The first groove 16 and the first pipe 22A are located above the ignition coil mounting portion 13 in the transverse direction, and the second groove 17 and the second pipe 22B are located below the ignition coil mounting portion 13 in the transverse direction.

FIG. 4 shows a straight line L1 extending along the head mounting surface 12 and a straight line L2 extending along a welding portion 18. The welding portion 18 is the section of the cover main body 11 on which the first pipe 22A of the oil shower pipe 22 is welded, that is, the section corresponding to the first groove 16 (the bottom wall of the first groove 16).

As shown in FIG. 4, the straight line L2 extending along the welding portion 18 is inclined with respect to the straight line L1 extending along the head mounting surface 12. The welding portion 18 is inclined in such a manner that the distance between the straight line L2 and the straight line L1 in the vertical direction decreases toward the left side in FIG. 4 (toward the second end of the cover main body 11 in the longitudinal direction). The welding portion 18, that is, the first groove 16 (the bottom wall of the first groove 16) is inclined with respect to the axis of the intake camshaft 94.

Like the first groove 16, the second groove 17 (the bottom wall of the second groove 17) is inclined with respect to the axis of the exhaust camshaft 93. The inclination angle and the inclination direction of the second groove 17 are the same as those of the first groove 16.

The first groove 16 and the second groove 17 form inclined surfaces that are inclined with respect to the axes of the camshafts 94, 93 on the front side of the cylinder head cover 10. Since the axis of the exhaust camshaft 93 extends horizontally, the inclined surfaces are inclined with respect to a horizontal plane. That is, the first groove 16 and the second groove 17 are inclined with respect to a horizontal line.

In a state in which the cylinder head cover 10 is mounted on the cylinder head 92, even the sections of the first groove 16 and the second groove 17 closest to the head mounting surface 12, that is, the second ends of the first groove 16 and the second groove 17 in the longitudinal direction are located above the head mounting surface 12.

A welding range WA in FIG. 2 shows a region where the oil shower pipe 22 is welded to the recess 15 among parts of the back side of the cylinder head cover 10 where the cover main body 11 and the baffle plate 21 are welded to each other. Since the first groove 16 is provided in such a manner that the straight line L2 is inclined with respect to the straight line L1, the depth of the recess 15 in the bulging portion on the second end is greater than that on the first end, and the depth increases toward the second end. The third groove extends from the second end of the first groove 16 to the second end of the second groove 17. Furthermore, the third groove may extend beyond the second end of the second groove 17 in the transverse direction of the cover main body 11.

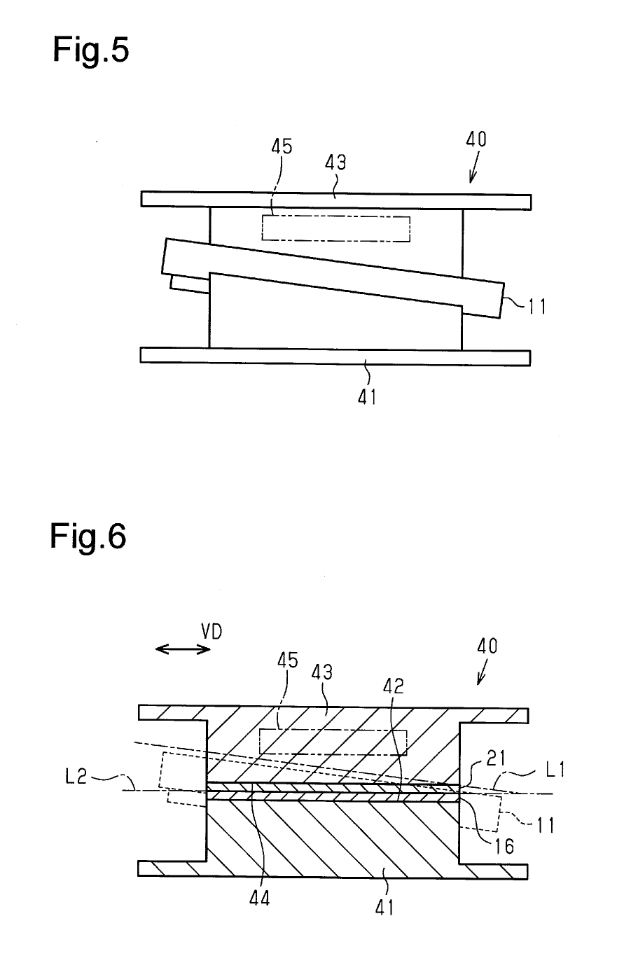

Next, a welding apparatus 40 for manufacturing the cylinder head cover 10 will be described with reference to FIGS. 5 and 6. More specifically, the welding apparatus 40 manufactures the cylinder head cover 10 by vibration welding of the baffle plate 21 to the cover main body 11.

The welding apparatus 40 includes a fixed jig 41 and a vibration jig 43. During welding, the cover main body 11 is placed on the fixed jig 41 with the front side abutting against the fixed jig 41. Furthermore, the baffle plate 21 is placed in such a manner that the front side abuts against the back side of the cover main body 11.

The fixed jig 41 has a recess abutting surface 42. The recess abutting surface 42 is placed to abut against the recess 15 of the cover main body 11. FIG. 6 shows the cross section at a position where the recess abutting surface 42 abuts against the bottom wall of the first groove 16 of the recess 15. The fixed jig 41 is configured to abut against the cover main body 11 from the front side of the cover main body 11 also at the joints other than the first groove 16.

The vibration jig 43 is configured to press the object to be welded placed on the fixed jig 41 from above. The vibration jig 43 includes a baffle abutting surface 44. The baffle abutting surface 44 abuts against the oil shower pipe 22 from the back side of the baffle plate 21. The vibration jig 43 is configured to abut against the baffle plate 21 from the back side of the baffle plate 21 also at the joints other than the oil shower pipe 22.

The welding apparatus 40 includes a vibration generating device 45. The vibration generating device 45 applies vibration to the vibration jig 43. FIG. 6 shows an arrow indicating a vibration direction VD of the vibration applied by the vibration generating device 45. The vibration direction VD matches with the horizontal direction.

When the vibration welding is performed by the welding apparatus 40, the fixed jig 41 and the vibration jig 43 hold the cover main body 11 and the baffle plate 21 in such a manner that the grooves 16, 17 (the straight line L2) are parallel to the vibration direction VD as shown in FIGS. 5 and 6. In other words, the fixed jig 41 and the vibration jig 43 secure the cover main body 11 and the baffle plate 21 in such a manner that the head mounting surface 12 (the straight line L1) is inclined with respect to the vibration direction VD.

When the vibration generating device 45 applies vibration to the vibration jig 43 in a state in which the fixed jig 41 and the vibration jig 43 secure the cover main body 11 and the baffle plate 21, the sections where the cover main body 11 and the baffle plate 21 abut against each other are welded.

An operation and advantages of the present embodiment will now be described.

The bulging portion of the cover main body 11 includes a recess 15 that is recessed inward from the front side. The recess 15 forms the first groove 16 and the second groove 17, which are inclined in the longitudinal direction of the cover main body 11.

In a state in which the cylinder head cover 10, which is mounted on the cylinder head 92, is applied to the internal combustion engine 90, the axial direction of the camshafts 93, 94 corresponds to the longitudinal direction of the cylinder head cover 10 (the left and right direction in FIG. 2), and the direction orthogonal to the axes of the camshafts 93, 94 corresponds to the transverse direction of the cylinder head cover 10. The cylinder head cover 10 mounted on the cylinder head 92 is inclined in the transverse direction. At this time, the third groove of the recess 15 is inclined in such a manner that the third groove extends from the second end of the first groove 16, while lowering toward the lower end of the cover main body 11. Liquid that has dropped on the front side of the cylinder head cover 10 flows to the first groove 16, the second groove 17, and the third groove. The liquid that has entered the first and second grooves 16, 17 flows from the first ends toward the second ends in the longitudinal direction along the inclination of the first and second grooves 16, 17. The liquid that has reached the second end of the first groove 16 flows through the third groove, meets the liquid that flows through the second groove 17, and is discharged toward the lower edge of the cylinder head cover 10. In this manner, since the front side of the cylinder head cover 10 is inclined in the transverse direction due to the mounting angle of the internal combustion engine 90 as shown in FIG. 1, the liquid flows downward. Thus, the liquid that may otherwise collect on the front side of the cylinder head cover 10 is discharged.

In a state in which the internal combustion engine 90 is installed in a vehicle, the bottom walls of the first groove 16 and the second groove 17 of the recess 15 are located below the ignition coils 81 and the cam angle sensor. This inhibits liquid from entering through the ignition coil mounting holes 13A and the sensor mounting hole 14, which are farther from the head mounting surface 12 than the bottom walls of the first groove 16 and the second groove 17. The configuration also inhibits adhesion of liquid to the ignition coils 81 and the cam angle sensor.

The bottom wall of the recess 15 welded to the baffle plate 21 functions as an inclined surface for letting the liquid to flow. Thus, the inclined surface is formed without providing an additional shape to the cover main body 11.

Furthermore, the bottom walls of the first groove 16 and the second groove 17 of the cylinder head cover 10 are inclined with respect to the head mounting surface 12. The bottom walls of the first groove 16 and the second groove 17 are located above the head mounting surface 12. Thus, it is only required to cause the head mounting surface 12 to abut against the cylinder head 92 to mount the cylinder head cover 10 on the cylinder head 92. The bottom walls of the first groove 16 and the second groove 17 do not interfere with the cylinder head 92. That is, even if the cylinder head cover 10 includes the recess 15, which constitutes the inclined surface, the efficiency in mounting the cylinder head cover 10 on the cylinder head 92 is not reduced.

The welding apparatus 40 includes the fixed jig 41, which includes the recess abutting surface 42, and the vibration jig 43, which includes the baffle abutting surface 44. Thus, the welding apparatus 40 holds the cover main body 11 and the baffle plate 21 in such a manner that the vibration direction VD is parallel to the grooves 16, 17 and welds the cover main body 11 and the baffle plate 21 to each other.

The present embodiment may be modified as follows. The present embodiment and the following modifications can be combined as long as the combined modifications remain technically consistent with each other.

In the above-described embodiment, the oil shower pipe 22 of the baffle plate 21 is welded to the bottom walls of the first groove 16 and the second groove 17. The part of the baffle plate 21 joined to the bottom walls of the first groove 16 and the second groove 17 is not limited to the oil shower pipe 22.

In the above-described embodiment, two grooves (the first groove 16 and the second groove 17) for discharging liquid are provided on the front side of the cylinder head cover 10. However, the number of the grooves does not necessarily have to be two. That is, one of the first groove 16 and the second groove 17 may be omitted. Alternatively, the number of the inclined grooves may be three or more. The grooves do not necessarily have to be parallel to each other. The third groove may be omitted. As long as the groove generally extends from the upper edge toward the lower edge on the front side of the cylinder head cover 10, the arrangement may be changed as required.

In the above-described embodiment, the inclination angle of the straight line L1 with respect to the straight line L2 may be changed as required. That is, the inclination angle of the first groove 16 and the second groove 17 may be changed as required. Alternatively, the inclination angles of the first groove 16 and the second groove 17 may be different from each other. The discharge destination of liquid that may possibly collect on the front side of the cylinder head cover 10 can be changed by changing the inclination angle and the installation angle of the internal combustion engine 90.

In the above-described embodiment, the length of the first groove 16 and the second groove 17 in the longitudinal direction may be changed.

In the above-described embodiment, the opening positions of the ignition coil mounting holes 13A or the sensor mounting hole 14, which are formed in the cover main body 11, may be changed as required. In a state in which the internal combustion engine 90 is installed in a vehicle, the ignition coil mounting holes 13A or the sensor mounting hole 14 is preferably located above the bottom walls of the first groove 16 and the second groove 17 of the recess 15.

The above-described embodiment illustrates the cam angle sensor mounted in the sensor mounting hole 14 as a sensor to be mounted in the cylinder head cover 10. If an electronic device other than the cam angle sensor mounted in the cylinder head cover 10 is located above the bottom walls of the first groove 16 and the second groove 17 of the recess 15, liquid is inhibited from being adhered to the electronic device as in the above-described embodiment.

In the above-described embodiment, the shapes of the fixed jig 41 and the vibration jig 43 of the welding apparatus 40 are merely examples. The shapes of the fixed jig 41 and the vibration jig 43 may be changed in accordance with the shapes of the cover main body 11 and the baffle plate 21.

1. A cylinder head cover mounted on a cylinder head of an internal combustion engine to cover a camshaft supported by the cylinder head, the cylinder head cover comprising:
a cover main body including a head mounting surface to be connected to the cylinder head and a bulging portion bulging away from the cylinder head farther than the head mounting surface, the bulging portion including a recess that is recessed to approach the head mounting surface, and the recess including a bottom wall inclined with respect to a horizontal plane in a state in which the cover main body is mounted on the internal combustion engine; and
a baffle plate joined to a surface of the bulging portion facing the camshaft at least at a section corresponding to the bottom wall of the recess.

2. The cylinder head cover according to claim 1, wherein
the recess extends along an axis of the camshaft and includes a first end and a second end in a longitudinal direction, and
the bottom wall of the recess is inclined in such a manner that the second end is lower than the first end in a state in which the cover main body is mounted on the internal combustion engine.

3. The cylinder head cover according to claim 2, wherein
the baffle plate includes an oil shower pipe configured to supply lubricant to a valve actuation mechanism of the internal combustion engine, and
the oil shower pipe is welded to the bottom wall of the recess.

4. A welding apparatus configured to perform vibration welding of the baffle plate to the cover main body to manufacture the cylinder head cover according to claim 1, the apparatus comprising:
a jig configured to secure the cover main body and the baffle plate with each other; and
a vibration generating device configured to apply vibration to the jig,
wherein the jig is configured to hold the cover main body and the baffle plate in such a manner that a vibration direction of vibration applied by the vibration generating device and the bottom wall of the recess are parallel to each other and that the baffle plate abuts against the bottom wall.
